(19) United States
(12) Patent Application Publication
(10) Pub. No.: US 2014/0289328 A1
(43) Pub. Date: Sep. 25, 2014

(54) OCCASION-BASED SOCIAL NETWORK

(71) Applicant: No Plan B Productions, LLC, Woodside, CA (US)

(72) Inventor: Sani El-Fishawy, Woodside, CA (US)

(73) Assignee: No Plan B Productions, LLC, Woodside, CA (US)

(21) Appl. No.: 14/095,877

(22) Filed: Dec. 3, 2013

Related U.S. Application Data
(60) Provisional application No. 61/732,874, filed on Dec. 3, 2012.
(60) Provisional application No. 61/732,887, filed on Dec. 3, 2012.

(51) Int. Cl. H04L 29/08

(52) U.S. Cl. CPC H04L 67/22
USPC 709/204

(57) ABSTRACT

An example embodiment includes an occasion-based social network. The occasion-based social network is configured to enable access to photos generated at an occasion by multiple individuals who attend the occasion. The occasion-based social network does not require prior relationships between the multiple individuals or an authority that invites the multiple individuals to a group associated with the occasion.

### CROSS-REFERENCE TO RELATED APPLICATIONS

This patent application claims the benefit of and priority to U.S. Provisional Patent Applications Nos.: 61/732,874 and 61/732,887 filed Dec. 3, 2012, which are incorporated herein by reference in their entireties.

### FIELD

Embodiments described herein relate to the creation and use of dynamically generated, self-organizing occasion-based social graphs.

### BACKGROUND

With advancements in mobile devices, social networks, and ubiquitous internet connectivity, the ability to generate photos and/or other media files (generically “media files”) and to communicate the media files has increased significantly in recent years. For example, an individual can easily take a photograph or a video with a smart phone and send the photograph or the video to the individual's friends. These advancements in technology have increased the number of media files generated and the number of individuals using devices to generate media files. With the increases in the number of individuals using devices to generate media files and the number of media files generated, it becomes increasingly difficult to share and access media files in an organized fashion.

Currently, individuals can utilize social networks to share and access photos and other media files. The three main types of social networks established today that enable sharing and accessing of photos and other media files include “friend request/accept” social networks, “follower” social networks, and “group-based, broadcasting” social networks. Each social network corresponds to a social graph, which is a data structure stored or represented in a tangible computer-readable medium. The social graph for each social network defines relationships between individuals and facilitates communication within the relationship model on which the social network is built.

Many photos are taken at occasions that have anywhere from a few to hundreds or more attendees. Such occasions include, for example, weddings, informal parties, barbecues, vacations, sporting events, school events, family outings, or any other events where multiple individuals assemble for a common activity or at a common location. Depending on the nature of the occasions, all or most attendees may know each other, there may be some level of acquaintance between attendees, or most attendees will have not yet met each other. In occasions that include more than one attendee, digital photos are taken and other media files are generated by multiple individuals. There is often a strong desire to share and see photos taken by other individuals at the occasion.

Each of the types of existing social networks enables individuals to share media files. However, each suffers from various drawbacks, particularly in relation to the ability to establish relationships that enable photos or other media files to be shared in a meaningful way in connection with occasions having multiple attendees. Specifically, in “friend request/accept” social networks, such as Facebook, when an individual shares media files from an occasion, the media file typically appears in the individual's friends feeds. These feeds are regulated by the social network's knowledge of the individual's friends and/or are regulated by general knowledge about the nature of the relationship between the individual and the individual's friends. The general knowledge may include a number of times a friend has commented and/or liked the individual's posts, for instance. By presenting the media file in the individual's feed regulated by the general information, the media file is not shared with individuals who were at the occasion, but are not the individual's friends, and who are likely interested in the media file. Additionally, the media file is shared with the friends who did not attend the occasion and who are probably not interested in viewing the media file. Because “friend/accept” social networks like Facebook do a poor job of discriminating which of an individual's friends are interested in seeing media files from a particular occasion, individuals tend to self-censor what they post out of fear of “spamming” friends in their social network who are not interested. Accordingly, individuals on a “friend/accept” social network like Facebook tend to submit only a few select photos from an occasion. Ideally individuals should be able to submit all of their photos or media files created at an occasion, have the photos preserved along with the photos created by others at the occasion, and have the social network intelligently organize and present them only to interested parties. Additionally, in “friend/accept” social networks, albums created by the individual are restricted to media files generated by the individual rather than compiling all media files generated at an occasion.

In “follower” social networks, such as Twitter and Instagram, the media files generated at an occasion are indiscriminately broadcast to all of an individual's followers. Many of the followers were not present at the occasion and likely not interested in the media files. Additionally, the individual cannot view or otherwise access the media files generated by other individuals who attended the occasion without establishing a follower relationship. Also, those at the occasion who are likely interested in the media files created by the individual may not get to see the photos of other attendees as they may not be followers of the individual on the social network. Additionally, in “follower” social networks, albums created by the individual are restricted to media files generated by the individual rather than compiling all media files generated at an occasion.

Likewise, in “group-based, broadcasting” social networks, such as Google Circles, an individual broadcasts a media file generated at an occasion to all individuals in the group. The group usually has been created prior to the occasion based on some commonality among the members of the group. Thus, the individual broadcasts the media file to potentially disinterested individuals who did not attend the occasion. In addition, the media files are only shared with the group, limiting access to individuals not included in the group who attended the occasion. Additionally, in “group-based, broadcasting” social networks, albums created by the individual are restricted to media files generated by the individual rather than compiling all media files generated at an occasion.

In sum, using the existing types of social networks, media files generated at an occasion are not viewable or accessible to all individuals who attended the occasion. Instead, the existing types of social networks restrict access to friends, followers, or members of a predefined group. Additionally, a viewing experience is based on a predefined relationship or irrelevant general information concerning the relationship between an individual who produced the media file and a friend. Finally, albums created by an individual are restricted to media files generated by the individual rather than compiling all media files generated at an occasion.

The subject matter claimed herein is not limited to embodiments that solve any disadvantages or that operate only in environments such as those described above. Additionally, unless otherwise indicated herein, the materials described herein are not prior art to the claims in the present application and are not admitted to be prior art by inclusion in this section. Rather, this background is only provided to illustrate one example technology area where some embodiments described herein may be practiced.

### SUMMARY

An example embodiment includes an occasion-based social network. The occasion-based social network is configured to enable access to photos generated at an occasion by multiple individuals who attend the occasion. The occasion-based social network does not require prior relationships between the multiple individuals or an authority that invites the multiple individuals to a group associated with the occasion.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of some embodiments, a more particular description will be rendered by reference to specific embodiments thereof, which are illustrated in the appended drawings. It is appreciated that these drawings depict only typical embodiments and are therefore not to be considered limiting of its scope. The invention will be described and explained with additional specificity and detail through the use of the accompanying drawings in which:

FIG. 1 illustrates an example system that establishes and provides access to an occasion-based social network;

FIG. 2 illustrates multiple participants whose photos are sent to a photo storage and are then available to generate albums in the system of FIG. 1;

FIG. 3 is a flow chart illustrating the generation of an example social graph that may be implemented in the system of FIG. 1; and

FIG. 4 is a block diagram illustrating an example computing device capable of being used in the system of FIG. 1, all arranged in accordance with at least some embodiments described herein.

### DESCRIPTION OF SOME EXAMPLE EMBODIMENTS

An example embodiment relates to occasion-based social networks (“social network”) and corresponding dynamically generated, self-organizing occasion-based social graphs (“social graphs”). The social graphs infer relationships between attendees at an occasion, between attendees across multiple occasions, and between individuals who later have interest in the occasion. Relationships may be inferred dynamically between attendees who were not acquainted with one another prior to the occasion. Creation of the social graph does not require a central authority or a single attendee at the occasion to explicitly establish a group or to expressly provide instructions to others to participate.

In this way, and for other reasons explained herein, the social networks described herein are different from, and have advantages not realized by conventional “friend request/accept” social networks, “follower” social networks, and “group-based, broadcasting” social networks. The social networks can be established in a dynamic and self-organizing way, in real-time during an occasion. The social networks are highly scalable and can accommodate large occasions with substantially any number of attendees.

When used in connection with an occasion having multiple attendees, the social networks described herein enable access to media files, such as photographs (hereinafter “photos”), generated at an occasion by as many as all individuals who attend the occasion. For simplicity in the discussion that follows, it is assumed that the media files include photos, with the understanding that the media files may alternately or additionally include video and/or other media files. Additionally, the social networks generate a dynamic viewing experience that prioritizes photos shown to individuals during a viewing or browsing experience based on a dynamically generated social graph.

The dynamic viewing experience incorporates inferences embodied in the social graph. Specifically these are inferences pertaining to the nature and strength of relationships between individuals who participate in the occasion-based social network. Specifically the dynamic viewing experience bases the inferences on one or more factors. Some factors include: identities of photographers (e.g., those who capture media files), identities of individuals in photos, a number of times identified individuals are in photos taken by a specific photographer, a number of occasions in which identified individuals are included in photos taken by a specific photographer, identities of individuals who appear together in photos, frequencies of the identified individuals' appearance together in photos, the number of occasions in which identified individuals appear together in photos, individuals that participants in the social network have tagged in photos, individuals invited by participants to participate at various occasions, individuals with which participants have shared photos, the number of occasions individuals have participated in together even though they may not have explicitly taken photos of one another or appeared in photos together, locations of where photos are taken, comments or other input by participants with respect to photos in which other individuals are tagged, browse history and preferences of participants, or quality of the photos (e.g., exposure, clarity, or the like).

One or more of the factors are weighed and/or combined to create the social graph. Based on the social graph, the dynamic viewing experience prioritizes the photos shown to a viewer.

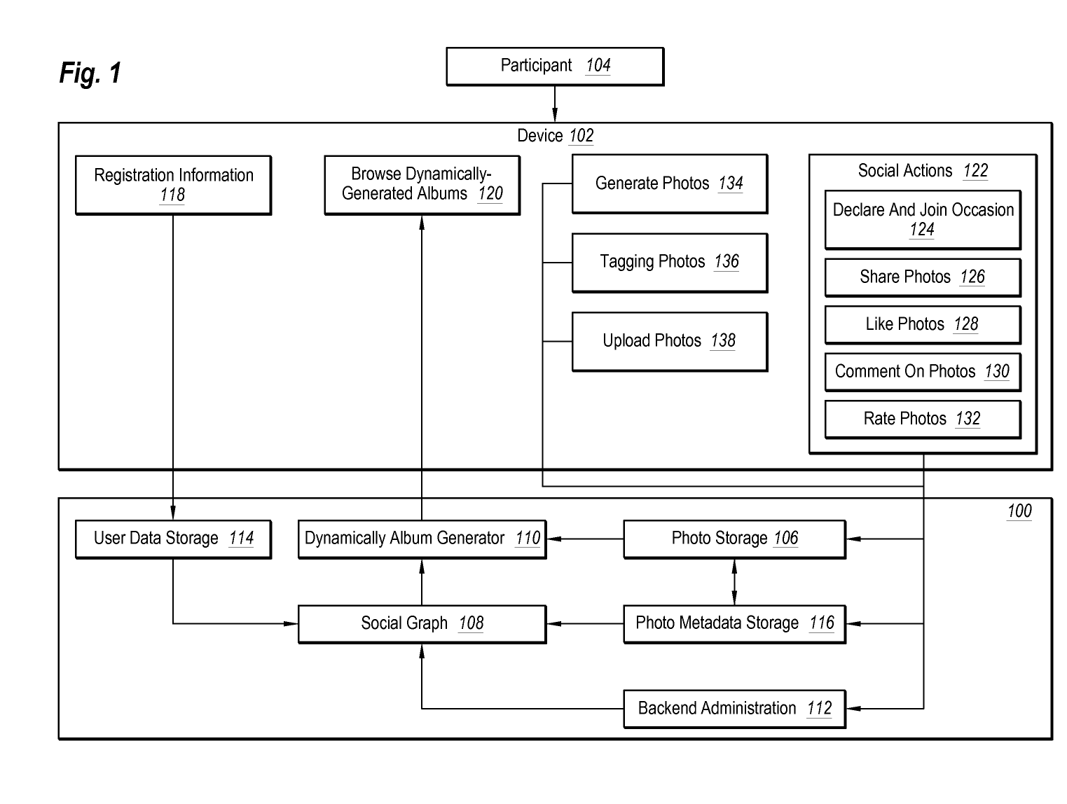

FIG. 1 illustrates an example system 100 that establishes and provides access to an occasion-based social network. Generally, to establish the occasion-based social network, the system 100 receives and processes media files such as photos and various other data communicated from a participant 104 operating a device 102. Additionally, to provide access to the photos, the system 100 includes a social graph 108 that infers relationships between the participant 104 and other individuals from the various data and the content of photos communicated by the participant 104. The social graph 108 interfaces with a dynamic album generator 110 to generate customized albums specifically tailored to the participant 104 and to allow the participant 104 to perform the action 120 of browsing dynamically generated albums using the device 102.

To explain the system 100, a basic photo contribution process is first provided herein with reference to FIG. 1. In a basic photo contribution process, the participant 104 attends an occasion along with multiple other attendees (not shown). At the occasion, the participant 104 uses the device 102 to perform the action 134 of generating a photo. The participant 104 then uses the device 102 to perform the action 138 of uploading the photo to a photo storage 106 included in the system 100. Alternately or additionally, the device 102 is used at the occasion to generate other media files including, but not limited to, video, other images, text messages, micro-blog or blog posts, or other types of media files. Likewise, although the term “photo storage 106” is used herein, the photo storage 106 can be adapted to receive and store any kind of media file. In the photo storage 106, all photos generated at an occasion are included in the photo storage 106 regardless of whether the participant 104 or another attendee created the photo.

In addition, the device 102 can be used to communicate other data related to the photo, the occasion, and the participant 104 to the system 100. The other data includes, but are not limited to, an identity of the photographer, identities of individuals in the photos, tagged individuals in the photos, and the location of the occasion. The other data pertaining to the photos can be stored at the photo storage 106, a photo metadata storage 116, a user data storage 114, and/or further communicated to a social graph 108.

For example, the device 102 can perform the action 118 of communicating registration information to the user data storage 114 included in the system 100. Additionally or alternatively, the device 102 provides the additional data by performing the action 136 of tagging individuals in photos or by performing social actions 122. The social actions 122 may include, but are not limited to, declaring and joining occasions 124, sharing photos (discussed below) 126, commenting on photos 130, rating photos 132, and liking photos 128. The metadata associated with tagging individuals and performing the social actions 122 is communicated to the system 100 and stored in the photo metadata storage 116.

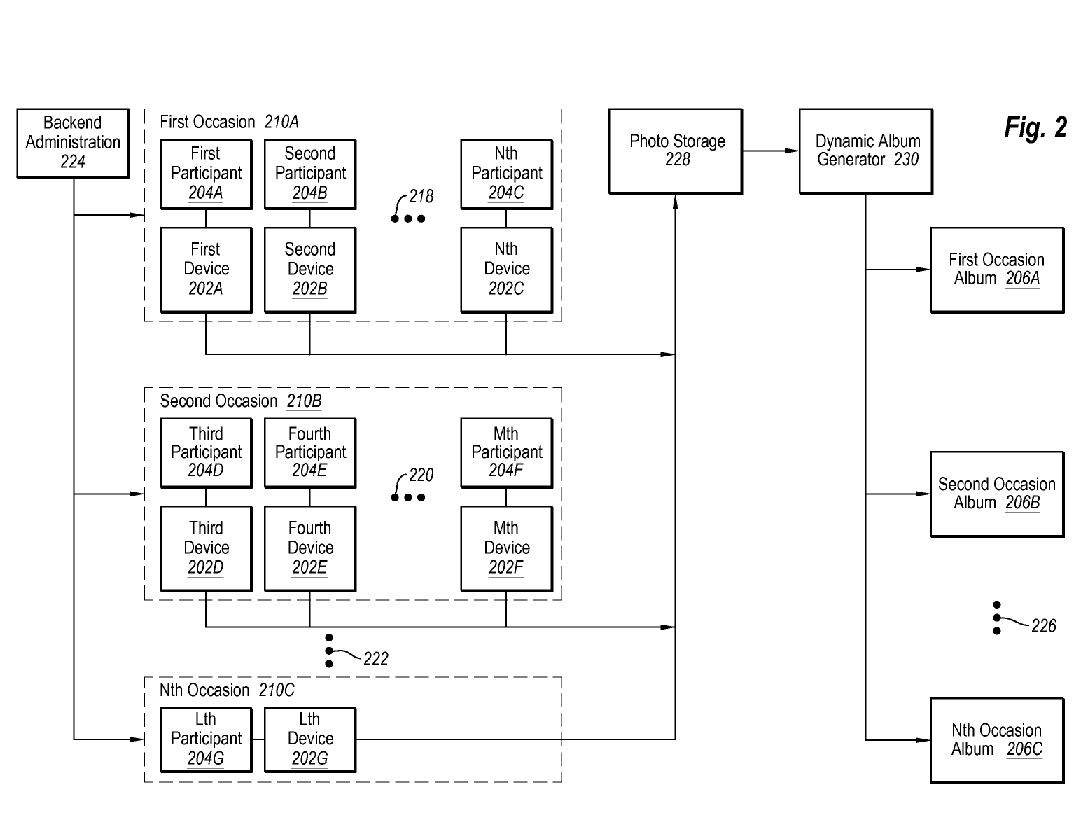

The system 100 of FIG. 1 depicts the interaction of one participant 104 and one device 102 with the social network. In the typical embodiment, there are multiple participants 104 and multiple devices 102 interacting with the social network. Some details of embodiments including multiple participants 104 and multiple devices 102 and resultant interface within the system 100 to establish an occasion-based social network are discussed with reference to FIG. 2.

Referring back to FIG. 1, participation in the system 100 by the participant 104 and other attendees of the occasion is self-organizing. That is, no attendee or authority creates the initial impetus to upload photos to the photo storage 106 or generates an album and then communicates to the attendees a need to contribute photos to the photo storage 106. Instead, participation in the system 100 spreads virally through the attendees at the occasion. The viral spread may begin for example by an initiating participant 104 seeding a first photo generated at the occasion using the device 102 and selecting from his device's contact list just a few of the attendees at the occasion that he happens to know. The initiating participant may also tag the attendee subjects in his first photo. A notification is then sent to the mobile devices of the attendees tagged in the first photo or attendees identified by the first user, inviting them to download an application implementing the system 100 and contribute photos to the photo storage 106. If the attendees accept the invitation, the photos generated by the attendees are contributed to the photo storage 106. This process continues, virally spreading among attendees at the occasion. The result is a dynamically created real-time photo storage 106 with photos combined therein for the occasion. Thus, the spread of participation among attendees is self-organizing and not directed by a single authority.

A backend administration 112 visualizes the viral spread of participation of attendees at the occasion in some embodiments. From the visualization, the backend administration 112 continually improves processes that spread participation of attendees at the occasion.

The system 100 and the device 102 are also capable of external sharing with non-attendees of an occasion 126. The participant 104 or any other individuals can share one or more photos from the photo storage 106 or an entire customized album via another social network or via email. A shared photo or shared album may display as a simple post with a thumbnail or a representative pictured from the album. Additionally, the thumbnail or the representative picture carries a link that allows a viewer of the shared photo or the shared album to participate with the system 100. For example, if the viewer uses a mobile device to view the shared photo, the link sends the viewer to a website. The website includes an additional link in which a mobile application for the system 100 is available for download.

The system 100 includes the dynamic album generator 110 that interfaces with the social graph 108 to generate the customized albums specifically tailored to the participant 104. The participant 104 can also perform the action 120 of browsing dynamically generated albums using the device 102. The participant 104 can thereby access the photos stored in the photo storage 106 that are presented to the participant 104 in a customized album. Moreover, through use of a device 102 any attendee of the occasion as well as any other individual who may be interested in a customized album can view and access the photos included the customized album. For example, a person who was not able to attend the occasion may be interested in viewing the photos from the occasion and view the photos from the occasion using a device 102.

Specifically, the dynamic album generator 110 automatically creates, without user input, a customized album that can be accessed by the participant 104, the attendees, and the other individuals. The customized album is created based on registration information 118 and metadata associated with the photos. The user data storage 114, the photo metadata storage 116, and information from the backend administration 112 communicate information to the social graph 108 on which the customized album can be based. For example, the customized album can be based on the photographer/attendee who took a photo, individuals tagged in a photo, location of the occasion, individuals who commented on a photo, a date when a photo is generated, most popularly rated photos, or quality of a photo, or the like or any combination thereof.

As used herein, the process of the participant 104, the attendees, and the other individuals browsing through dynamically generated albums 120 and generally creating and providing access to a customized album is referred to as a “browsing experience.” For example, a browsing experience includes the participant 104 browsing the photos in a customized album that has been created based on one or more metadata fields.

Additionally, the dynamic album generator 110 interfaces with the social graph 108 to prioritize the photos included in the customized album and thus prioritizes the photos presented to the participant 104, the attendee, or the other individuals during a browsing experience. Thus, the device 102 presents the photos in the customized album in a way explicitly tailored to the participant 104, the attendees, or the other individuals.

More specifically, the dynamic album generator 110 through its interface with the social graph 108 incorporates inferences of the nature and strength of relationships between individuals who use the system 100 and are the subjects of the photos. The dynamic album generator 110 bases the inferences on one or more factors. The factors stem from various data (e.g., photo metadata and regular information) input to the system 100 or are derived from the various data. For example, some of the factors include the metadata communicated by the participant 104 to the photo metadata storage 116 pertaining to the occasion and/or to a photo; some of the factors are derived from the other data over multiple occasions and multiple customized albums; and some of the factors include data from individuals browsing the dynamically generated albums.

The factors upon which the one or more inferences are made include: identities of photographers (e.g., those who capture media files), identities of individuals in photos, the number of times identified individuals are in photos taken by a specific photographer, the number of occasions in which identified individuals are included in photos taken by a specific photographer, identities of individuals who appear together in photos, frequencies of the identified individuals' appearance together in photos, the number of occasions in which identified individuals appear together in photos, individuals that participants (e.g. participant 104) in the system 100 have tagged in photos, individuals invited by participants (e.g. participant 104) to participate in the system 100, individuals with which participants (e.g. participant 104) have shared photos, a number of occasions individuals have participated in together even though they may not have explicitly taken photos of one another or appeared in photos together, locations of where photos are taken, comments or other input by participants (e.g. participant 104) with respect to photos in which other individuals are tagged, browse history and preferences of participants, or a quality of the photos (e.g., exposure, clarity, or the like).

The factors are weighed and/or combined to create the social graph 108. Based on the social graph 108, dynamic album generator 110 prioritizes the photos included in a customizable album and shown during a browser experience to a particular participant. Thus, each participant (e.g., participant 104) sees a version of an album which is likely to be of greatest interest to him based on his relationship in the social graph with the subjects and authors of the photos he is shown. Each individual has a browsing experience for an occasion that is explicitly tailored and most relevant to him.

The backend administration 112 measures the depth of engagement in browsing experiences. The backend administration 112 uses these measurements to test prioritization schemes for each individual. Thus, the prioritization scheme can evolve to maximize utility for the participant who is browsing.

FIG. 2 illustrates multiple participants 204A-204G (generally, “participant(s)” 204) contributing photos to a photo storage 228 that may be included in the system 100 of FIG. 1. A dynamic album generator 230 has access to the photo storage 228 and from the photos stored in the photo storage 228, the dynamic album generator 230 can generate multiple albums 206A-206C (generally, “album(s)” 206). Each of the participants 204 are associated with a device 202A-202G (generally, “device(s) 202) used to generate photos at an occasion 210A-210C (generally, “occasion(s)” 210).

In the embodiment depicted in FIG. 2, a first participant 204A, a second participant 204B, and an Nth participant 204C are attending a first occasion 210A. The first participant 204A, the second participant 204B, and the Nth participant 204C are associated with a first device 202A, a second device 202B, and an Nth device 202C, respectively. Likewise, a third participant 204D, a fourth participant 204E, and an Mth participant 204F are attending a second occasion 210B. The third participant 204D, the fourth participant 204E, and the Mth participant 204F are associated with a third device 202D, a fourth device 102E, and an Mth device 202F, respectively.

The photos generated by the first device 202A, the second device 202B, and the Nth device 202C, while the first participant 204A, the second participant 204B, and the Nth participant 204C are attending the first occasion 210A, are contributed to the photo storage 228 from which the dynamic album generator 230 can generate a first occasion album 206A. Likewise, the photos generated by the third device 202D, the fourth device 202E, and the Mth device 202F, while the third participant 204D, the fourth participant 204E, and the Mth participant 204E are attending the second occasion 210B, are contributed to the photo storage 228 from which the dynamic album generator 230 can generate a second occasion album 206B.

As depicted in FIG. 2, the first participant 204A, the second participant 204B, and the Nth participant 204C are attending the first occasion 210A; the third participant 204D, the fourth participant 204E, and the Mth participant 204F are attending the second occasion 210B; and an Lth participant 204G may be attending an Nth occasion 210C. Use of the generalized “Nth,” “Mth,” and “Lth” along with ellipses 218, 220, 222, and 226 are meant to indicate that there may be more or fewer participants 204, mobile devices 202, occasions 210, or occasion albums 206 than explicitly illustrated in FIG. 2. Additionally, any subset of the occasions 210 may be occurring simultaneously or may overlap in duration.

Additionally, in some embodiments, a backend administration 224 visualizes a number of participants 204 at the occasions 210. Accordingly, the backend administration 224 can monitor a spread of participation among attendees. From the visualization, the backend administration 224 can continually improve processes that spread participation among attendees at the occasions 210.

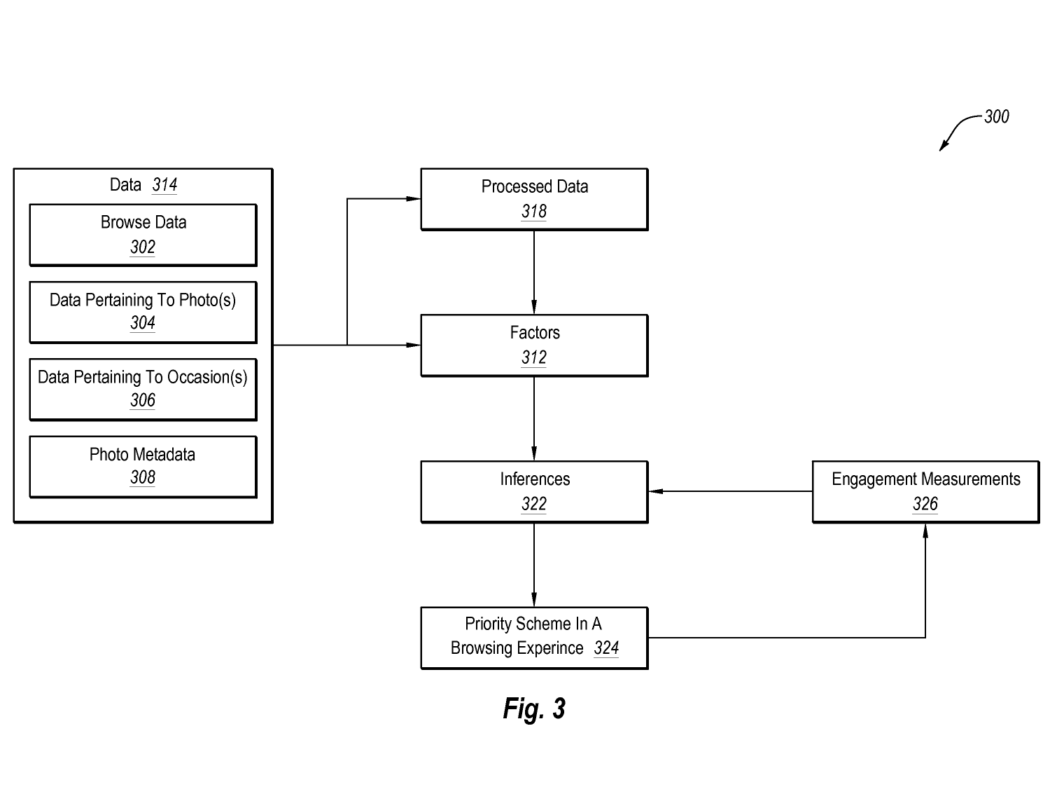

FIG. 3 is a block diagram illustrating the generation of an example social graph 300 that may be implemented in the system 100 of FIG. 1. Data 314 such as browser data 302, data pertaining to photos 304, data pertaining to occasions 306, and photo metadata 308 is obtained. The data 314 are used to produce factors 312. Some data 314, in and of themselves are factors 312 and are used directly as factors 312 without processing. Other data 314 is processed into processed data 318, which are factors 312. The processed data 318 can include data 314 from multiple occasions, for instance.

The factors 312 are weighed and/or combined to generate inferences 322. The inferences 322 relate to relationships between users of the social network. For example, the inferences 322 may include the strength or nature of the relationship between users, such as familial relationships, friendships, etc.

The inferences 322 are used to generate priorities schemes in a browsing experience (“priority schemes”) 324. The priority schemes 324 are individualized, such that a user of a dynamic viewer, such as dynamic viewer 110 of FIG. 1, is shown photos according to a set of inferences 322, factors 312, and data 314 involving the user.

The generation of the social graph 300 does not require explicit identification by users of friends or relationships. Accordingly, the generation of the social graph 300 is dynamic. Additionally, in some embodiments, the generation of the social graph 300 is at least partially occasion-based.

Additionally, the generation of the social graph 300 is configured to evolve. Specifically, engagement measurements 326 are taken to assess the engagement by the user based on the priority scheme 324. The engagement measurements 326 are fed back to alter or modify the inferences 322 to improve the priority scheme 324. For example, based on engagement measurements 326 a weight of a factor 312 can be changed in generating a corresponding inference 322.

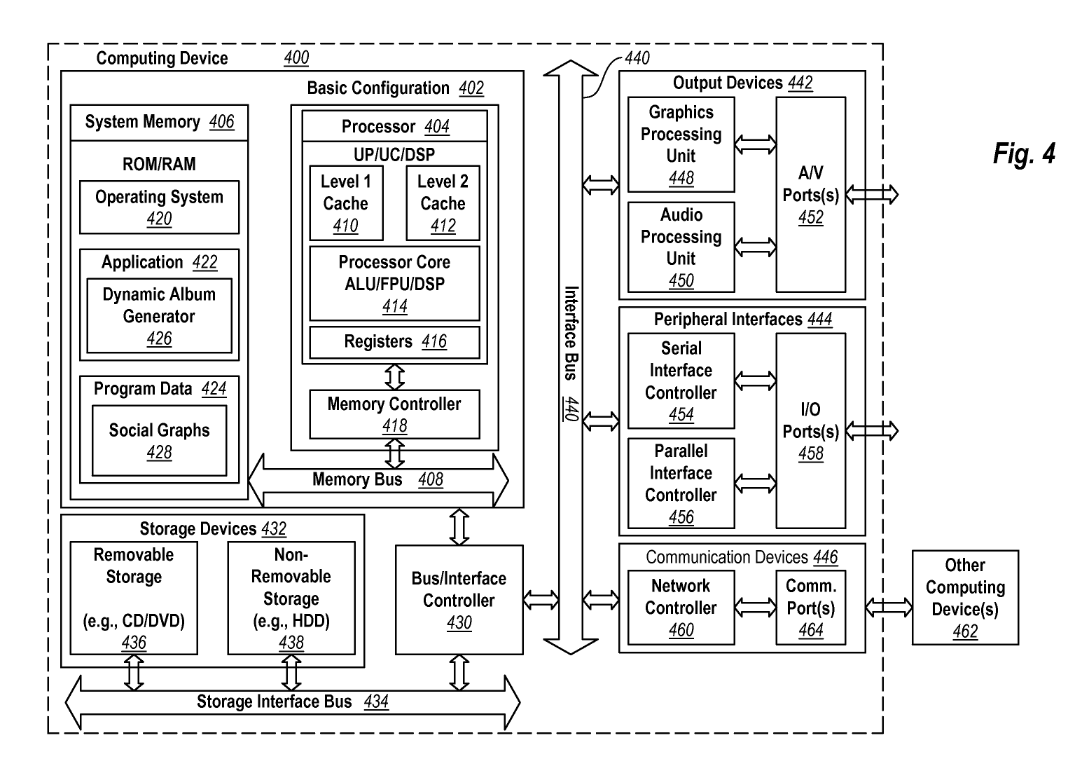

FIG. 4 is a block diagram illustrating an example computing device 400 arranged for operating a social network, such as the system 100 of FIG. 1, arranged in accordance with at least some embodiments described herein. In a very basic configuration 402, the computing device 400 typically includes one or more processors 404 and a system memory 406. A memory bus 408 may be used for communicating between the processor 404 and the system memory 406.

Depending on the desired configuration, the processor 404 may be of any type including but not limited to a microprocessor (μP), a microcontroller (μC), a digital signal processor (DSP), or any combination thereof. The processor 404 may include one or more levels of caching, such as a level one cache 410 and a level two cache 412, a processor core 414, and registers 416. An example processor core 414 may include an arithmetic logic unit (ALU), a floating point unit (FPU), a digital signal processing core (DSP Core), or any combination thereof. An example memory controller 418 may also be used with the processor 404, or in some implementations the memory controller 418 may be an internal part of the processor 404.

Depending on the desired configuration, the system memory 406 may be of any type including but not limited to volatile memory (such as RAM), non-volatile memory (such as ROM, flash memory, etc.) or any combination thereof. The system memory 406 may include an OS 420, one or more applications 422, and program data 424. The application 422 may include a dynamic album generator 426 arranged to perform the functions as described herein. The program data 424 may include social graphs 428 generated as is described herein. In some embodiments, the application 422 may be arranged to operate with the program data 424 on the OS 420 to perform methods for operating a social network as described herein. This described basic configuration 402 is illustrated in FIG. 4 by those components within the inner boxed area.

The computing device 400 may have additional features or functionality, and additional interfaces to facilitate communications between the basic configuration 402 and any required devices and interfaces. For example, a bus/interface controller 430 may be used to facilitate communications between the basic configuration 402 and one or more data storage devices 432 via a storage interface bus 434. The data storage devices 432 may be removable storage devices 436, non-removable storage devices 438, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 406, removable storage devices 436, and non-removable storage devices 438 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 440 for facilitating communication from various interface devices (e.g., output devices 442, peripheral interfaces 444, and communication devices 446) to the basic configuration 402 via the bus/interface controller 430. Example output devices 442 include a graphics processing unit 448 and an audio processing unit 450, which may be configured to communicate to various external devices such as a display or speakers via one or more A/V ports 452. Example peripheral interfaces 444 include a serial interface controller 454 or a parallel interface controller 456, which may be configured to communicate with external devices such as input devices (e.g., keyboard, mouse, pen, voice input device, touch input device, etc.) or other peripheral devices (e.g., printer, scanner, etc.) via one or more I/O ports 458. An example communication device 446 includes a network controller 460, which may be arranged to facilitate communications with one or more other computing devices 462 over a network communication link via one or more communication ports 464.

The present invention may be embodied in other specific forms without departing from its spirit. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An occasion-based social network configured to enable access to photos generated at an occasion by multiple individuals who attend the occasion without requiring prior relationships between the multiple individuals or an authority that invites the multiple individuals to a group associated with the occasion.

2. The occasion-based social network of claim 1, further configured to generate a dynamic viewing experience that prioritizes photos shown to individuals during a browsing experience based on a dynamically generated social graph.

3. The occasion-based social network of claim 2, wherein the dynamic viewing experience incorporates inferences of the nature and strength of relationships between individuals who use the occasion-based social network (“an occasion-based social graph”).

4. The occasion-based social network of claim 3, wherein the dynamic viewing experience bases the inferences on one or more factors.

5. The occasion-based social network of claim 4, wherein the factors comprise:
identities of photographers;
identities of individuals in photos;
a number of times identified individuals are in photos taken by a specific photographer;
a number of occasions in which identified individuals are included in photos taken by a specific photographer;
identities of individuals who appear together in photos;
frequencies of the identified individuals' appearance together in photos;
a number of occasions in which identified individuals appear together in photos;
individuals that participants in the occasion-based social network have tagged in photos;
individuals invited by participants to participate in the occasion-based social network;
individuals with which participants have shared photos;
a number of occasions individuals have participated in together;
locations of where photos are taken;
comments or other input by participants with respect to photos in which other individuals are tagged;
browse history and preferences of participants; or
a quality of the photos.

6. A data structure, residing in a tangible computer-readable medium, for establishing a social graph that implements the occasion-based social network of claim 1.
